(19) United States
(12) Patent Application Publication
(10) Pub. No.: US 2001/0037283 A1
(43) Pub. Date: Nov. 1, 2001

(54) Systems, methods, and computer program products for facilitating the establishment of cross-referral agreements among members of a marketing community

(76) Inventor: Julian S. Mullaney, Raleigh, NC (US)

Correspondence Address: MYERS BIGEL SIBLEY & SAJOVEC, PO BOX 37428, RALEIGH, NC, 27627, US

(21) Appl. No.: 09/812,747

(22) Filed: Mar. 20, 2001

Related U.S. Application Data
(60) Provisional application No. 60/192,161, filed on Mar. 27, 2000.

(51) Int. Cl. G06F 17/60

(52) U.S. Cl. 705/37; 705/26; 705/10; 705/14; 709/203

(57) ABSTRACT

Systems, methods, and computer program products that facilitate the establishment of cross-referral agreements among members of a marketing community (i.e., businesses) are provided. A communications server is configured to send messages to clients (i.e., customers and/or potential customers) of members pursuant to cross-referral agreements between members. An agreement server is configured to allow members of the marketing community to negotiate and establish cross-referral agreements with other members of the marketing community. A virtual area contains member provided information. members of the marketing community can search information contained within the virtual area to identify potential partners to cross-referral agreements. Members can transfer rights in cross-referral agreements to other members of the marketing community.

### RELATED APPLICATIONS

This application claims the benefit of U.S. Provisional Application No. 60/192,161, filed Mar. 27, 2000.

### FIELD OF THE INVENTION

The present invention relates generally to commerce and, more particularly, to promoting commerce via the Internet.

### BACKGROUND OF THE INVENTION

As the Web has evolved into a viable commercial medium, advertising has become an important source of revenue for many commercial entities. Web pages served from commercial Web sites often utilize advertising to promote various goods and services. On-line advertising via the internet conventionally involves the use of “banner” advertisements within Web pages. A banner advertisement conventionally is an advertisement in the form of a graphic image of a designated pixel size and byte size limit that typically runs across a Web page or is positioned in a margin or other space reserved for ads. When a user views a web page displaying a banner advertisement, the user may then try to find out more information regarding the advertisement (or the business entity providing the advertisement) by selecting the advertisement (“clicking through” on the banner ad) through the use of a mouse or other pointing device.

However, in advertising, it is considered highly desirable to target advertisements and other promotional efforts to specific consumers (often referred to as “direct marketing”), rather than to broadcast advertisements to consumers in general, such as via banner advertising. By targeting advertising to individual consumers, the likelihood may be increased that a consumer will read and act upon the advertising. As such, various efforts have been made to implement direct marketing via e-mail transmitted over the Internet in order to deliver customized advertising to targeted consumers.

Unfortunately, public opinion regarding unsolicited e-mail (often referred to as “spam”) may have dampened somewhat the effectiveness and success of conventional direct marketing campaigns conducted via e-mail. Moreover, successful direct marketing campaigns typically require specific information about consumers that are being targeted. Unfortunately, previous direct marketing efforts may have been somewhat unsuccessful in obtaining information sufficient to conduct effective direct marketing campaigns.

### SUMMARY OF THE INVENTION

In view of the above, embodiments of the present invention provide systems, methods, and computer program products that facilitate the establishment of cross-referral agreements (e.g., e-mail cross-referral agreements) among members of a marketing community (e.g., businesses). An e-mail server hosted by an intermediary is configured to send e-mail messages to clients (e.g., customers and/or potential customers) of members of the marketing community pursuant to cross-referral agreements between members of the marketing community.

According to embodiments of the present invention, a virtual area is hosted by the intermediary at the Web site of the intermediary. The virtual area is accessible by members of the marketing community and contains member provided information. Members of the marketing community can search information contained within the virtual area to identify potential partners to e-mail cross-referral agreements. Moreover, members of the marketing community can negotiate and establish e-mail cross-referral agreements with other members of the marketing community via the intermediary Web site.

According to embodiments of the present invention, the intermediary can handle the transfer of fees between members who have established e-mail cross-referral agreements with each other. According to other embodiments of the present invention, members of the marketing community can sell or trade rights in e-mail cross-referral agreements with other members of the marketing community. For example, the intermediary may allow members to conduct auctions wherein other members of the marketing community can bid on existing e-mail cross-referral agreements.

Embodiments of the present invention can offer several advantages over conventional methodologies for delivering advertising via the Internet. Members of a marketing community can use e-mail cross-referral agreements to reach targeted customer segments with a higher probability of purchase, and at a lower cost than with traditional advertising. The use of e-mail cross-referral agreements can open a vast customer pool to which targeted solicitation can be made without violating laws and regulations relating to unsolicited e-mail. Moreover, embodiments of the present invention may facilitate the generation of additional revenues to members of a marketing community by allowing them to sell “piggyback” rights in various cross-referral agreements with other members.

### BRIEF DESCRIPTION OF THE DRAWINGS

FIG. 1 schematically illustrates a marketing community wherein members of the marketing community utilize the services of an intermediary for delivery of e-mail messages and for entering into cross-referral agreements, according to embodiments of the present invention.

FIG. 2 is a block diagram that schematically illustrates the Web site of the intermediary of FIG. 1 that can be utilized by members of a marketing community for entering into cross-referral agreements, according to embodiments of the present invention.

FIG. 3 is an exemplary e-mail message generated by the intermediary of FIG. 1 on behalf of a member of the marketing community.

FIGS. 4-5 are exemplary Web pages containing cross-referral information about other members of the marketing community, according to embodiments of the present invention.

FIG. 6 is a flow chart illustrating operations for establishing e-mail cross-referral agreements among members of a marketing community, according to embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout the description of the drawings.

As will be appreciated by one of skill in the art, the present invention may be embodied as methods, data processing systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

Computer program code for carrying out operations of the present invention may be written in object oriented programming languages (e.g., JAVA®, Smalltalk or C++) and/or may also be written in conventional procedural programming languages (e.g., “C”). However, embodiments of the present invention do not depend on implementation with a particular programming language. Program code for carrying out aspects of the present invention may execute entirely on a single data processing system, or it may execute partly on one data processing system and partly on one or more other data processing systems (e.g., a proxy server at an intermediate point in a communications network).

The present invention is described below with reference to block diagram and/or flowchart illustrations of methods, apparatus (systems) and computer program products according to an embodiment of the invention. It is understood that each block of the block diagram and/or flowchart illustrations, and combinations of blocks in the block diagram and/or flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function(s) specified in the block diagram and/or flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagram and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

A preferred communications network with which the present invention may be utilized is the Internet. As is known to those of skill in the art, the Internet is a worldwide decentralized network of computers having the ability to communicate with each other. The World-Wide Web (Web) is comprised of server-hosting computers (Web servers) connected to the Internet that are configured to serve hypertext documents (Web pages) and/or other types of files to requesting clients (e.g., Web browsers) utilizing the Hypertext Transfer Protocol (HTTP) via a Transmission Control Protocol/Internet Protocol (TCP/IP) connection between a client-hosting device and a server-hosting device.

A Web site is conventionally a related collection of Web files that includes a beginning file called a “home” page. From the home page, a visitor can access other files and applications at a Web site. A large Web site may utilize a number of servers, which may or may not be different and which may or may not be geographically-dispersed. For example, the Web site of the International Business Machines Corporation (www.ibm.com) consists of thousands of Web pages and files spread out over multiple Web servers in locations world-wide.

A Web server (also referred to as an HTTP server) is a computer program that utilizes HTTP to serve files that form Web pages to requesting Web clients. Exemplary Web servers are International Business Machines Corporation's family of Lotus Domino® servers and the Apache server (available from www.apache.org). A Web client is a requesting program that also utilizes HTTP. A browser is an exemplary Web client for use in requesting Web pages and files from Web servers. A Web server waits for a Web client, such as a browser, to open a connection and to request a Web page. The Web server then sends a copy of the requested Web page to the Web client, closes the connection with the Web client, and waits for the next connection.

To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized with the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects a particular hypertext link, a browser running on the user's client device reads and interprets an address, called a Uniform Resource Locator (URL) associated with the link, connects the browser with a Web server at that address, and makes a request (e.g., an HTTP request) for the file identified in the link. The Web server then sends the requested file to the client device which the browser interprets and renders within a display screen.

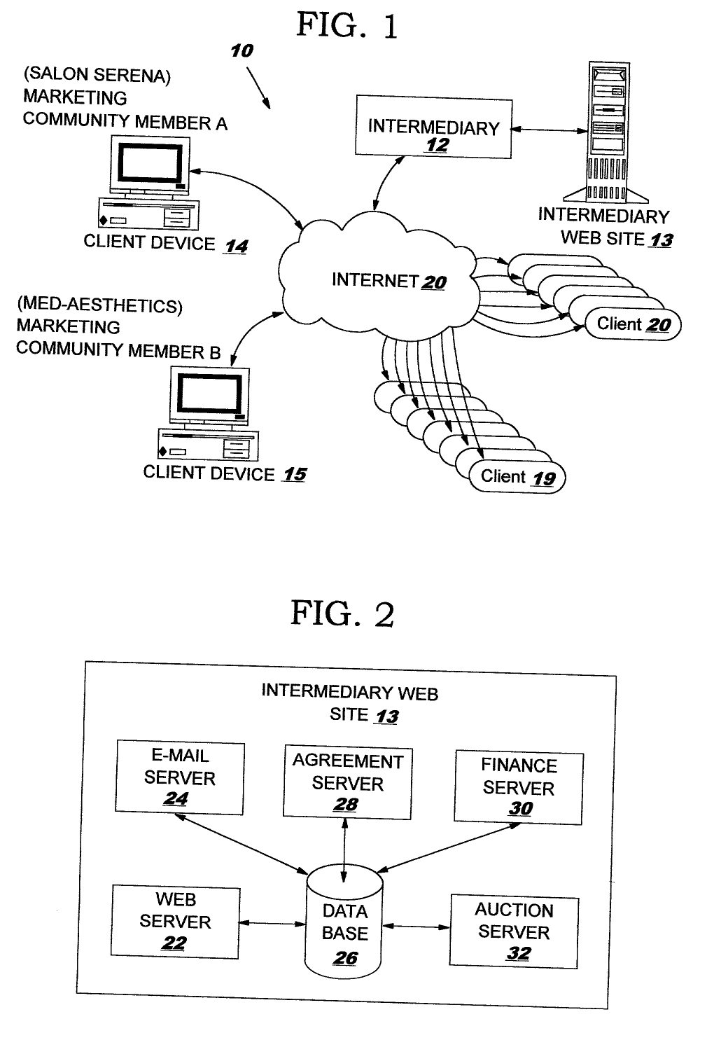

Referring now to FIG. 1, a marketing community is comprised of a plurality of members (e.g., businesses, individuals, and/or organizations) that utilize the services of an intermediary 12 to deliver e-mail messages, and/or other forms of communications, to potential and/or existing customers (hereinafter referred to as “clients”). Businesses and/or organizations within a marketing community may include businesses and/or organizations with an online presence (i.e., a Web site), as well as traditional “bricks and mortar” businesses and/or organizations that do not have an online presence. The illustrated marketing community includes member A and member B; however, it is understood that a plurality of members may be serviced by the intermediary 12 in accordance with embodiments of the present invention.

The intermediary 12 provides e-mail delivery services on behalf of members A and B to clients of members A and B. For example, e-mail messages may be sent to the clients of member A at predetermined times, such as holidays, birthdays, when member A is having a sale, and the like. Moreover, the services provided by the intermediary 12 may include various tracking and reporting functions, such as response rates to e-mail messages sent to clients.

In addition, the intermediary 12 may implement viral referral marketing programs on behalf of members of the marketing community, and handle the logistics, tracking and payments associated with such referral schemes. As is known to those of skill in the art, a viral referral system may involve asking a visitor of a business (actual or virtual via the Web) for data (usually e-mail addresses, etc.) of their friends and associates so that they can then be solicited to purchase products and/or services offered by the business. Once they are solicited, they can refer even more friends and the cycle repeats and grows. The most effective viral referral programs usually involve some sort of reward which provides an incentive to the person to provide information about other people. Rewards take many forms including cash, discounts on future purchases, etc.

Although e-mail messages are described as the primary means of communicating, it is understood that embodiments of the present invention may use telephonic communications as the primary means of communicating. In such a case, a referrer may submit the telephone numbers of their friends, family, and associates to the intermediary 12 and the intermediary 12 will then send a referral message to their telephone, wireless telephone number or wireless internet address. Embodiments of the present invention may also use HTML e-mail messages or e-mail messages which make use of many other types of rich media such as embedded graphics, sound files, and moving graphics within the communication message. Furthermore, the messages may be sent directly to a communications device such as a wireless device capable of receiving graphical, or audible messages which may or may not be email messages. Messages may also be transmitted via postal services (e.g., conventional mail).

According to embodiments of the present invention, the intermediary 12 may accept voice activated input of telephone numbers or e-mail addresses of contacts using voice recognition technologies. In such a case, a referrer could speak the name of a friend whose personal contact information resides on their cellphone address book, and the intermediary 12 would then receive the contact information from the addressbook. The intermediary 12 may accept the input of email addresses, names, telephone numbers, dates, addresses and other information associated with the identity of the person, or the nature of the business transaction or the marketing community members A, B. The marketing community members A, B may submit this information to the intermediary 12 via a wide variety of methods including but not limited to email, telephone, input via a secure or non-secure web interface with the intermediary itself, voice, or in written form.

Still referring to FIG. 1, marketing community members A and B communicate with a Web site 13 of the intermediary 12 via a client program, such as a browser, running on respective client devices (e.g., personal computers) 12, 14 over a communications network, such as the Internet 20. In general, however, marketing community members may communicate with the intermediary Web site 13 using various types of client devices including, but not limited to, personal computers, personal digital assistants (PDAs), portable computers, hand-held computers, cellular telephones, Internet-ready phones, WebTVs, and the like.

In FIG. 1, marketing community member A has a plurality of clients 19 associated therewith, and marketing community member B has a plurality of clients 20 associated therewith. As described above, these clients may include actual customers of members A and B and/or potential customers thereof. Members A and B utilize the services of the intermediary 12 to send e-mail messages to clients 19 and 20, respectively. According to embodiments of the present invention, marketing community members A and B can enter into e-mail cross-referral agreements such that information about one of the members is included in e-mail messages sent on behalf of the other member to clients of the other member. The messages may contain information within the e-mail such as a hyperlink leading to a Web page which then contains information about either of the members.

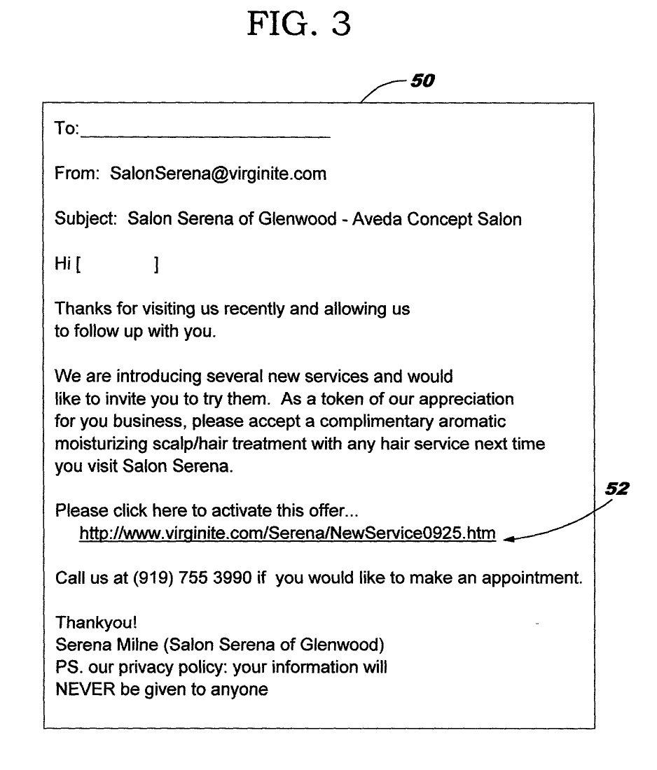

Referring now to FIG. 2, an intermediary web site 13 which serves as an intermediary marketing communication system that facilitates sharing of information and the establishment of e-mail cross-referral agreements among members of a marketing community, according to embodiments of the present invention, is illustrated. The illustrated intermediary Web site 13 includes a Web server 22, an e-mail server 24, a database 26, an agreement server 28, a finance server 30, and an auction server 32.

The Web server 22 includes program code, logic and/or graphics that can generate a “virtual area” that is remotely accessible by members of the marketing community via various types of client devices and that contains information about members of the marketing community that the members themselves provide. Some members of the marketing community may not be interested in attracting partners and, thus, may chose to post little or even zero information about themselves. Such members of the marketing community are primarily interested in using the services of the intermediary for sending regular and/or timed email messages to their own clients as described above. Other members of the marketing community, however, may be very interested in “partnering” (i.e., entering into e-mail cross-referral agreements with other marketing community members). Accordingly, these members may wish to provide a lot of information about themselves so that they have a higher chance of another member approaching them to initiate a cross referral agreement.

The Web server 22 may be configured to allow members of the marketing community to post any type of information about themselves (i.e., build an electronic resume). For example, members can post information such as how many clients they have, a description of the nature of their business, the location of their business, ZIP codes of their businesses, statistics showing what percentage of their clients respond to the e-mails that they send to them, demographic information about a member's clients, and the like. Web servers are well known to those of skill in the art and need not be described further herein.

Members of the marketing community may receive an ID and password from the intermediary for use in accessing the virtual area, for adding/editing information within the virtual area, and for viewing/searching the information that other members of the marketing community have chosen to reveal about themselves. Entry of information into an electronic resume within the virtual area is preferably performed via a series of menus, radio buttons, text boxes and/or other conventional user interface tools utilized in HTTP client/server communications. Information within a member's electronic resume resides within a database 26 maintained by the intermediary 12.

Members of the marketing community may search the virtual area for information about other members using menus, radio buttons, text boxes and/or other conventional user interface tools utilized in HTTP client/server communications. For example, after logging in, a member can pull down a menu entitled “find a partner”. This would produce a text search box where they can search the electronic resumes of all the other marketing community members who have posted information within the virtual area. Preferably, various types of search capabilities may be provided, such as “enter the ZIP code near the area in which where you are searching for partners” and “display marketing community members within a (fill in the blank) mile radius”, and the like. Moreover, members may search the virtual area for other members who sell products and/or services that are competitive, complimentary, and/or neutral with respect to the member's products and/or services.

Exemplary Web servers that may be utilized in accordance with embodiments of the present invention are Apache, available from the Apache Server Project, http://www.apache.org; Microsoft's Internet Information Server (IIS), available from Microsoft Corporation, Redmond, Wash.; and Netscape's FastTrack® and Enterprise™ servers, available from America Online, Inc., Dulles, Va. Other Web servers that may be utilized in accordance with embodiments of the present invention include Novell's Web Server for users of its NetWare® operating system, available from Novell, Inc., San Jose, Calif.; and IBM's family of Lotus Domino® servers, available from International Business Machines Corporation, Armonk, N.Y.

The e-mail server 24 is a remotely accessible application that members of the marketing community can access via client devices and that sends e-mail messages to clients of members as described above. Moreover, the e-mail server 24 is configured to include information about a member within e-mail messages sent on behalf of another member to clients of the other member pursuant to an e-mail cross-referral agreement between the members, as will be described below. E-mail servers are well known to those of skill in the art and need not be described further herein.

Embodiments of the present invention are not limited to e-mail servers. Communication servers configured to send messages of various types and formats may be utilized.

The agreement server 28 is a remotely accessible application that members of the marketing community can access via client devices and that allows members of the marketing community to negotiate and establish e-mail cross-referral agreements with other members. Members of the marketing community may negotiate an agreement with other members using menus, radio buttons, text boxes and/or other conventional user interface tools utilized in HTTP client/server communications. For example, a member may download a form from the agreement server that allows the member to enter information associated with the type of e-mail cross-referral agreement the member wishes to establish with another member.

Exemplary information that a member would enter into such a form may include, but is not limited to: the names of the two agreeing marketing community members; whether the partnering members will append e-mail messages with information about each other; whether “landing pages” (described below) will be generated for the partnering members, and whether e-mail messages will contain links to these landing pages; whether the agreement between the members is an unlimited reciprocal agreement (no cash transaction); and whether the agreement between the members is a non-reciprocating agreement, and is there any payment from member A to member B for appending member A's information onto member B's email messages to their clients.

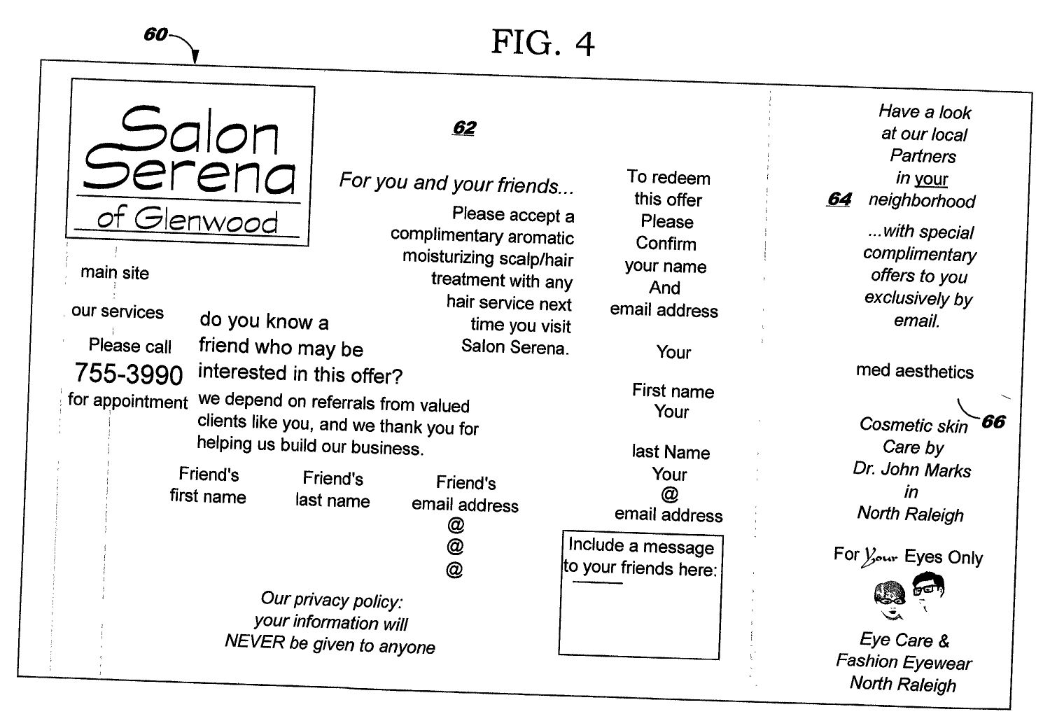

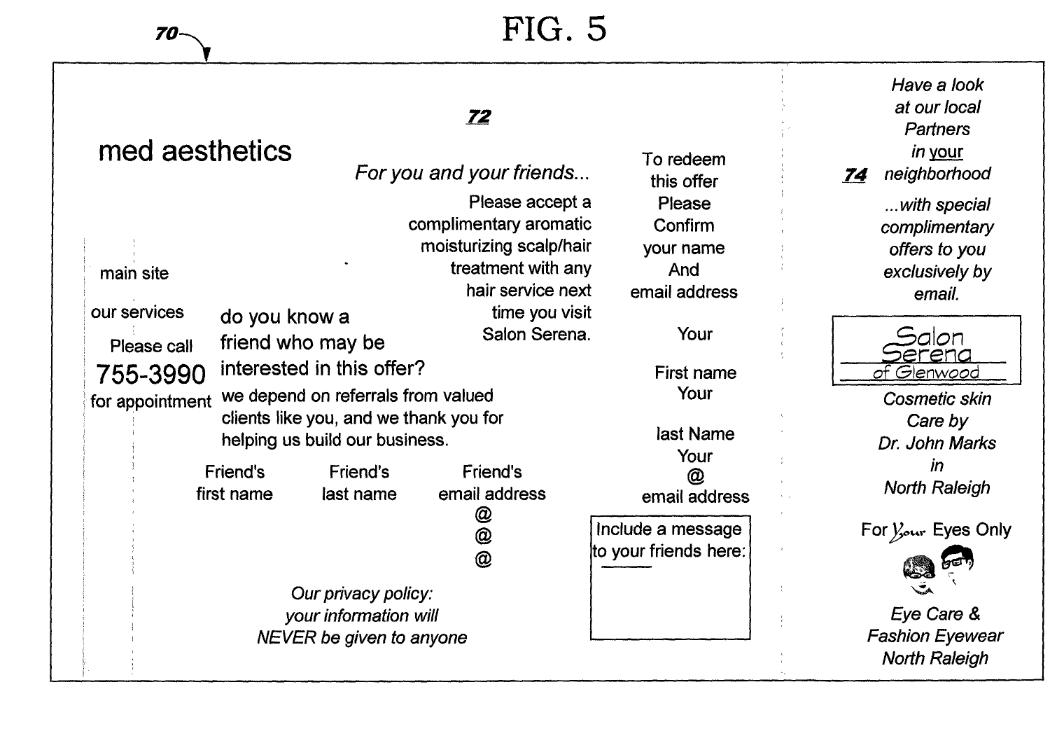

Referring now to FIGS. 3-5, e-mail cross-referral agreements will be described. A client of marketing community member A (Salon Serena) receives an e-mail message 50 via the intermediary service as illustrated in FIG. 3. The illustrated e-mail message 50 contains a link 52 that leads to member A's “landing page” 60, as illustrated in FIG. 4. The landing page 60 may be a Web page hosted by the intermediary, or may be a Web page from the Web site of member A. The illustrated landing page 60 includes a portion 62 containing information about member A, and a portion 64 containing information about member B (Med-Aesthetics) pursuant to a cross-referral agreement between member A and member B.

Landing page portion 64 contains a user-activatable link 66 to a landing page 70 as illustrated in FIG. 5. The landing page 64 may be a Web page hosted by the intermediary 12, or may be a Web page from the Web site of member B. The illustrated landing page 70 includes a portion 72 containing information about member B, and a portion 74 containing information about member A pursuant to the cross-referral agreement between member A and member B.

Alternatively, the same graphics and links may be contained within an HTML email message which appears directly within the recipient's e-mail client (e.g., the Microsoft Outlook® e-mail client). HTML e-mail messages are well known to those of skill in the art and need not be described further herein. This embodiment avoids the additional step of clicking a link within a text e-mail message. A further embodiment may use only simple text e-mail messages sent by the members which contain additional text concerning their partner members. This method is used for members who do not have websites of their own, and do not wish to employ the “landing page” method.

The auction server 32 is a remotely accessible application that members of the marketing community can access via client devices and that is configured to allow members of the marketing community to conduct auctions or negotiations leading to an agreement for selling or trading rights in e-mail cross-referral agreements with other members. The auction server 32 may allow members to conduct one or more on-line auctions, including auctions with various formats, in real time. Alternatively, the agreement reaching process may be conducted between individual members in a non-auction style process which is not conducted in real time. Auction servers are well known to those of skill in the art and need not be described further herein.

The finance server 30 is a remotely accessible application that members of the marketing community can access via client devices and that is configured to handle the transfer of fees between members who have established e-mail cross-referral agreements with each other. The finance server 30 is configured to allow members to conduct various financial transactions, including financial transactions in real time.

Application program code for performing various functions of the Web server 22, the e-mail server 24, the agreement server 28, the finance server 30, and the auction server 32 may be implemented as Common Gateway Interface (CGI) applications. As is understood by those of skill in the art, CGI is a standard that allows client programs to interface with various applications via web servers. A Web server processes a client program CGI request using a CGI script or application. For example, when a database is queried by a client program, a web server acts as a gateway between the database and the client program. The web server transmits the client program request to a CGI application that performs the database query, formats the results and returns HTML-formatted data to the web server. The web server then transmits the HTML-formatted data to the client program for display to the user.

It is understood that the present invention is not limited to the use of CGI applications. For example, Microsoft Active Server Pages (ASP) technology and Java Server Pages (JSP) technology may be utilized to perform the various functions of the Web server 22, the e-mail server 24, the agreement server 28, the finance server 30, and the auction server 32 in accordance with embodiments of the present invention.

Alternatively, the functions of the Web server 22, the e-mail server 24, the agreement server 28, the finance server 30, and the auction server 32 may be performed by applications executing on a single server or on multiple servers.

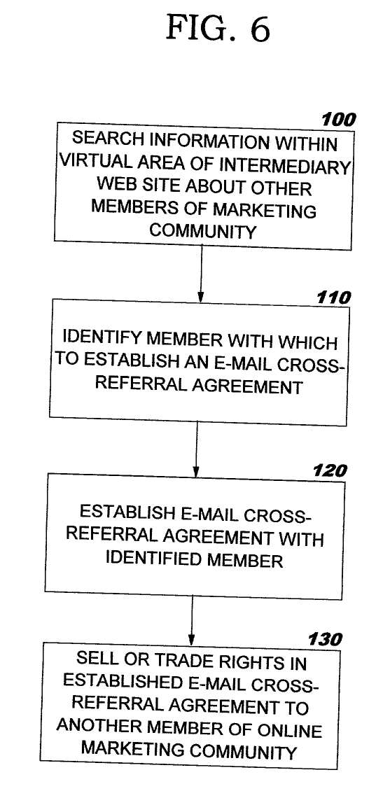

Referring now to FIG. 6 operations for establishing cross-referral agreements among members of a marketing community, according to embodiments of the present invention, are illustrated. Although e-mail cross-referral agreements are specifically illustrated in FIG. 6, it is understood that embodiments of the present invention are intended to incorporate any type of cross-referral agreement.

A member of a marketing community searches information about other marketing community members contained within a virtual area of an intermediary Web site (Block 100). Based upon information within the virtual area, the member identifies another member with whom the member wishes to establish a cross-referral agreement (e.g., an e-mail cross referral agreement) (Block 110). For example, the member may select another member because products and/or services offered by the two members are complementary.

The two members negotiate and establish an e-mail cross-referral agreement via an agreement server hosted by the intermediary (Block 120). Such an agreement may include various provisions. For example, information about (or leading to) one of the members may be included within e-mail messages sent on behalf of the other member by an e-mail server hosted by the intermediary.

According to additional embodiments of the present invention, rights in established e-mail cross-referral agreements may be sold or traded to other members of the marketing community (Block 130). For example, the intermediary may provide the ability for members to conduct auctions for rights in e-mail cross-referral contracts.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An intermediary marketing communication system that facilitates the establishment of cross-referral agreements among members of a marketing community, comprising an agreement server that is remotely accessible by members of the marketing community, and that is configured to allow members of the marketing community to negotiate and establish cross-referral agreements with other members of the marketing community.

2. The intermediary marketing communication system according to claim 1, further comprising:
a virtual area that is remotely accessible by members of the marketing community and that contains member provided information; and
means for allowing members to search member provided information contained within the virtual area to identify potential partners to cross-referral agreements.

3. The intermediary marketing communication system according to claim 1, further comprising a financial server that is remotely accessible by members of the marketing community, and that is configured to handle the transfer of fees between members who have established cross-referral agreements with each other.

4. The intermediary marketing communication system according to claim 1, further comprising means for allowing members to sell or trade rights in cross-referral agreements with other members.

5. The intermediary marketing communication system according to claim 4, wherein the means for allowing members to sell or trade rights in cross-referral agreements with other members comprises an auction server that is remotely accessible by members of the marketing community, and that is configured to allow members to conduct auctions for rights in cross-referral agreements.

6. The intermediary marketing communication system according to claim 1, wherein the means for allowing members to search member provided information within the virtual area comprises means for allowing members to identify at least one of goods and/or services offered by other members and/or locations of other members.

7. The intermediary marketing communication system according to claim 1, further comprising means for allowing members to add and/or edit information contained within the virtual area.

8. The intermediary marketing communication system according to claim 1, further comprising a communications server that is configured to send messages to clients of members, and that is configured to include information about a member within messages sent on behalf of another member to clients of the other member pursuant to a cross-referral agreement between the members.

9. The intermediary marketing communication system according to claim 8, wherein messages sent by the communications server are selected from the group consisting of e-mail messages, HTML e-mail messages, graphical messages, moving graphical messages, and audible messages.

10. An intermediary marketing communication system that facilitates the establishment of cross-referral agreements among members of a marketing community, comprising:
a communications server hosted by an intermediary, wherein the communications server is configured to send messages to clients of members, and wherein the communications server is configured to include information about a member within messages sent on behalf of another member to clients of the other member pursuant to a cross-referral agreement between the members;
a virtual area that is remotely accessible by members of the marketing community and that contains member provided information;
means for allowing members to search member provided information contained within the virtual area to identify potential partners to cross-referral agreements;
an agreement server that is remotely accessible by members of the marketing community, and that is configured to allow members of the marketing community to negotiate and establish cross-referral agreements with other members; and
means for allowing members to sell or trade rights in cross-referral agreements with other members.

11. The intermediary marketing communication system according to claim 10, wherein messages sent by the communications server are selected from the group consisting of e-mail messages, HTML e-mail messages, graphical messages, moving graphical messages, and audible messages.

12. The intermediary marketing communication system according to claim 10, wherein the means for allowing members to sell or trade rights in cross-referral agreements with other members comprises an auction server that is remotely accessible by members of the marketing community, and that is configured to allow members to conduct auctions for rights in cross-referral agreements.

13. The intermediary marketing communication system according to claim 10, further comprising a financial server that is remotely accessible by members of the marketing community, and that is configured to handle the transfer of fees between members who have established cross-referral agreements with each other.

14. The intermediary marketing communication system according to claim 10, wherein the means for allowing members to search member provided information within the virtual area comprises means for allowing members to identify at least one of goods and/or services offered by other members and locations of other members.

15. The intermediary marketing communication system according to claim 10, further comprising means for allowing members to add and/or edit information contained within the virtual area.

16. A method of establishing cross-referral agreements among members of a marketing community, the method comprising the following steps performed by a member of the marketing community via a Web site of an intermediary:
searching information about other members of the marketing community contained within a virtual area of the intermediary Web site;
identifying a member with which to establish a cross-referral agreement; and
establishing a cross-referral agreement with the identified member via an agreement server such that information about one of the members is included within messages sent on behalf of the other member by the intermediary.

17. The method according to claim 16, wherein the step of searching information about other members of the marketing community contained within a virtual area of the intermediary Web site comprises searching at least one of information about goods and/or services offered by other members and/or locations of other members.

18. The method according to claim 16, further comprising selling or trading rights in the established cross-referral agreement to another member of the marketing community.

19. The method according to claim 18, wherein the step of selling or trading rights in the established cross-referral agreements to another member of the marketing community is performed via an auction server.

20. A computer program product for establishing cross-referral agreements among members of a marketing community, the computer program product comprising a computer usable storage medium having computer readable program code embodied in the medium, the computer readable program code comprising:
computer readable program code for searching information about other members of the marketing community contained within a virtual area of a Web site of an intermediary;
computer readable program code for identifying a member with which to establish a cross-referral agreement; and
computer readable program code for establishing a cross-referral agreement with the identified member via an agreement server such that information about one of the members is included within messages sent on behalf of the other member by the intermediary.

21. The computer program product according to claim 20, wherein the computer readable program code for searching information about other members of the marketing community contained within a virtual area of the intermediary Web site comprises computer readable program code for searching information about at least one of goods and/or services offered by other members and/or locations of members.

22. The computer program product according to claim 20, further comprising computer readable program code for selling or trading rights in the established cross-referral agreement to another member of the marketing community.

23. The computer program product according to claim 22, wherein the computer readable program code for selling or trading rights in the established cross-referral agreements to another member of the marketing community comprises computer readable program code for conducting an auction via the intermediary Web site.
